(19) United States
(12) Patent Application Publication
(10) Pub. No.: US 2025/0251961 A1
(43) Pub. Date: Aug. 7, 2025

(54) ENFORCEMENT OF MAXIMUM MEMORY ACCESS LATENCY FOR VIRTUAL MACHINE INSTANCES

(71) Applicant: Intel Corporation, Santa Clara, CA (US)

(72) Inventors: Long Cui, Shanghai (CN); Ripan Das, Beaverton, OR (US); Litrin Jiang, Shanghai (CN); Wenhui Shu, Shanghai (CN); Rameshkumar Illikkal, Folsom, CA (US); Andrzej Kuriata, Gdansk (PL); Rohan Tabish, Schaumburg, IL (US)

(73) Assignee: Intel Corporation, Santa Clara, CA (US)

(21) Appl. No.: 18/855,075

(22) PCT Filed: Jun. 30, 2022
(86) PCT No.: PCT/CN2022/102928

§ 371 Date: Oct. 8, 2024

(51) Int. Cl. G06F 9/455

(52) U.S. Cl. CPC G06F 9/45558; G06F 2009/45583

(57) ABSTRACT

Enforcement of maximum memory access latency for virtual machine instances is described. An example of a computer-readable storage medium includes instructions to implement operation of multiple virtual machines (VMs) in a cloud computing system; monitor operation of the VMs in processing a set of active workloads, including monitoring of memory access latency for the VMs using a dynamic resource controller, the dynamic resource controller comprising hardware circuitry to monitor memory bandwidth usage; and, upon detecting memory access in the cloud computing system reaching a memory bandwidth setpoint, implementing memory access throttling of one or more of the set of active workloads for the plurality of VMs, and allocating memory bandwidth to the active workloads according to a distribution algorithm.

### TECHNICAL FIELD

This disclosure generally relates to the field of computing devices and, more particularly, enforcement of maximum memory access latency for virtual machine instances.

### BACKGROUND

Cloud service (also referred to cloud computing or other related terms) refers to the provision of computer system resources by cloud service providers to one or more clients, The computer system resources that are provided may include computing (such as in the form of servers), data storage (cloud storage), databases, networking, software, analytics, intelligence, and others.

In public computing cloud operation, virtual machine (VM) based instances may be supported on behalf of clients to run applications. In operation, the virtual machines share the same hardware, and further share the memory bandwidth in the physical machines that are employed in the provision of cloud services.

The performance of virtual machines in a cloud environment is dependent on the resources that available to process workloads for the virtual machines. In such operation, very high memory bandwidth usage by certain virtual machines can result in higher memory access latency for clients using certain other virtual machines, and thus result in significant performance variations in public cloud processing.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of an apparatus or system to provide enforcement of maximum memory access latency for virtual machine instances, according to some embodiments;

FIG. 2A is an illustration of a process for enforcement of maximum memory access latency for virtual machine instances, according to some embodiments;

FIG. 2B is an illustration of equitable memory bandwidth allocation, according to some embodiments;

FIG. 2C is an illustration of priority-based memory bandwidth allocation, according to some embodiments;

FIG. 3 is an illustration of an example computing system;

FIG. 4 illustrates an example of dynamic control of memory bandwidth allocation according to some embodiments;

FIG. 5 is a flow diagram illustrating example dynamic control of memory bandwidth allocation processing according to some embodiments;

FIG. 6 is a flow diagram illustrating a delay balancer processing according to some embodiments;

FIG. 7 illustrates an embodiment of an exemplary computing architecture for operations including enforcement of maximum memory access latency for virtual machine instances, according to some embodiments;

FIG. 8 is a block diagram of an example processor platform structured to execute the machine readable instructions or operations, according to some embodiments;

FIG. 9 is a block diagram of an example implementation of processor circuitry; and

FIG. 10 is a block diagram illustrating an example software distribution platform.

### DETAILED DESCRIPTION

Embodiments described herein are directed to enforcement of maximum memory access latency for virtual machine instances.

Cloud service (also referred to cloud computing or other related terms) refers to the provision of computer system resources over a network to one or more clients, where the computer system resources may include computing (such as in the form of servers), data storage (cloud storage), databases, networking, software, analytics, intelligence, and others. The computer system resources in a cloud infrastructure are provided and supported without direct active management by the user, and include functions distributed over multiple locations, the locations being referred as data centers. Cloud infrastructure may include cloud software (e.g., Software as a Services (SaaS)), a cloud platform (e.g., Platform as a Service (PaaS), and cloud infrastructure (e.g., Infrastructure as a Service (IaaS)), and may be employed on a private, community, and/or public cloud.

Public cloud service may include the support for virtual machine processing. Virtual machine (VM) refers to a virtualization or emulation of a computer system, which may enable hosting of one or more applications for clients of a cloud service provider. The public cloud service may include operation of a virtual machine manager (VMM, or hypervisor), which refers to software that creates and runs virtual machines. A VMM allows one host computer to support multiple guest VMs by virtually sharing its resources, such as memory and processing.

In the provision of public cloud services to clients, cloud service providers commonly define certain values relating to virtual machine instances. This may include implementation of one or more service level agreements. As used herein, a service level agreement (SLA) in general refers to an agreement between a service provider and a service client regarding services provided, where the agreement may include, but is not limited to, commitments by the service provider to provide certain levels of service, which may include quality, availability, and responsibilities for service. An SLA may include multiple metrics that reflect the level of service being provided. In this manner, a client may be promised a certain quality of service (QoS). As used herein, quality of service (QoS) refers to a description or measurement of an overall performance of a service, such as a service provided by a cloud service provider, network, or other system. The values that are provided in relation to virtual machine operation may include the VCPU (Virtual Central Processing Unit) core count, memory size, network bandwidth, storage bandwidth for a virtual machine instance.

However, these values do not address memory access latency, referring to an amount of time to access memory storage in cloud services. Issues as a result of memory access latency variations can result in significant performance variations between VMs in public cloud processing, thus making the memory access latency an important value in evaluating system operation. Further, memory latency is closely connected to the level of use of memory bandwidth, and in particular usage that nears a saturation point. In circumstances in which a system reaches a memory bandwidth saturation point, it may appear that the CPU is engaged, but the CPU is forced to wait for data from memory in order to perform work. As used herein, memory bandwidth refers to a rate at which data is read from or written into memory, and memory bandwidth saturation refers to condition in which an operation consumes a full allocated amount of memory bandwidth.

Cloud service providers do not control what workloads are run by applications in virtual machines, and adverse conditions may arise quickly depending on the type of workload that is introduced into the cloud service environment. In circumstances in wherein there is memory bandwidth saturation, CPU utilization may be very high without there being effective performance in processing of the relevant virtual machines because an operation is waiting for data for processing. A secondary effect of high memory latency is that the CPU utilization may reach a peak in response to the memory bandwidth saturation, with customers then suffering heavy performance regression.

In existing technologies, certain capabilities related to memory bandwidth control may be implemented through the characterization of each workload, and the use of such characterizations in memory bandwidth control of the workloads. However, the characterization of each workload creates a significant burden on the customers in establishing a system operation.

In some embodiments, memory performance in terms of memory access latency may be provided via a new service level agreement. A service level agreement establishing a maximum memory access latency for VM based instances in a public cloud may be applied by a cloud service provider, thereby allowing a cloud end customer to receive improved unified memory performance. The provision of memory according to the SLA in cloud computing may be utilized to reduce the performance variations in VMs in the public cloud.

In some embodiments, a cloud service provider is to utilize a dynamic resource controller (DRC) for memory bandwidth allocation. As used herein, a dynamic resource controller (which provides dynamic resource control) refers to hardware to allocate memory resources, a dynamic resource controller including the capability to monitor (track) memory bandwidth usage, and to detect memory bandwidth saturation. The establishment and application of a dynamic resource controller is described in U.S. Patent Application Publication 2020/0210332 A1. The application of a dynamic resource controller including hardware circuitry to provide memory bandwidth controls allow for rapid response to conditions in which one or more workloads are utilizing excessive amounts of memory bandwidth and driving the system into saturation.

In some embodiments, an apparatus or system includes an adjustable memory bandwidth setpoint (which may also be referred to as a memory bandwidth threshold), the memory bandwidth setpoint being an amount of memory bandwidth usage that is authorized in a system. When the setpoint is reached, then the apparatus or system will operate to throttle memory bandwidth for high memory bandwidth workloads by engaging the dynamic resource controller to allocate memory bandwidth among the active workloads being processed by virtual machines running in the apparatus or system according to a distribution algorithm. In some embodiments, the throttling of memory bandwidth usage includes delaying memory accesses to reduce the bandwidth usage, where the throttling is based at least in part on the proportion processor core count utilized by virtual machines. In some embodiments, the throttling of memory bandwidth usage results in reduction in memory access latency, which peaks in response to high bandwidth usage, and is utilized in maintaining a maximum memory access latency according to an SLA.

In contrast with processes that may be implemented by characterizing each work workload, an embodiment provides for memory bandwidth monitoring and control without requiring characterization of workloads. An embodiment may be utilized independent of the nature of any active workloads, with a single memory bandwidth setpoint being established to address any of the workloads that are processed in a system. When the saturation point is reached and the dynamic resource controller is engaged, an embodiment provides a fair throttling operation in which the most aggressive workloads will be throttled more than the other active workloads, and wherein the memory bandwidth can be distributed as needed for a particular system.

In some embodiments, a distribution method or algorithm may be selected or implemented to direct how memory bandwidth is to be allocated among virtual machines. A distribution algorithm may include, but is not limited to:
(a) An equitable distribution algorithm, in which each active workload is allocated a same or similar memory bandwidth.
(b) A priority distribution algorithm, in which memory bandwidth is allocated to active workloads according to a priority level. For example, workloads that are designated as a high priority are allocated a first amount of memory bandwidth and workloads that are designated as low priority are allocated a second amount of memory bandwidth, the first amount being greater than the second amount. However, embodiments are not limited to these priority levels.

In some embodiments, the memory bandwidth setpoint may be selected for a system, where different systems may have different setpoint requirements. The setpoint may be chosen based on one or more preferences for customers. The selection of a setpoint may have certain consequences that may be taken into account in establishing a setpoint level, For example, a lower (i.e., more restrictive) setpoint will prevent excessive bandwidth usage, which may be used to minimize impact on higher priority virtual machines before the DRC is engaged and begins to allocate memory bandwidth among workloads. However, the selection of a lower setpoint will limit the ability of virtual machines to utilize higher bandwidth levels for workload processing in instances when this be useful. In contrast, selection of a higher (i.e., less restrictive) setpoint allows more flexibility of memory bandwidth usage, but may have certain impact on virtual machines (such as high priority virtual machines) when a noisy workload is processed during the time before the DRC is engaged and has successfully allocated the memory bandwidth among active workloads in the system. A relaxed setpoint may allow a brief initial period when workloads will be running in noisy conditions. Thus, the particular usage of a system may be a factor in establishing a relaxed (higher) memory bandwidth or a stringent (lower) memory bandwidth setpoint. Stated in another way, the customer may select how much reliability they wish to enforce in a system, versus how much flexibility in memory bandwidth usage they wish to allow.

In some embodiments, a dynamic resource controller may apply close loop control to provide memory bandwidth throttling. The memory bandwidth throttling may be applied to maximize the memory bandwidth utilization rate in VMs and to provide fair memory bandwidth allocation between VMs in a system. In an operation, while the memory traffic is low or idle, each of the active workloads processed by VM instances may be able to utilize a maximum memory bandwidth for the workload. When the memory traffic is busy, the DRC is to detect the memory bandwidth contentions, allowing the system to apply the VM core count proportional bandwidth throttling. In this manner, each VM instance may be accorded memory access that that meets the maximum memory access latency according to the applicable service level agreement. In some embodiments, close loop memory bandwidth control is provided by hardware, with real time memory bandwidth monitoring and control being implemented. Such operation may be implemented without requiring additional overhead for the automagical memory traffic monitoring and allocation.

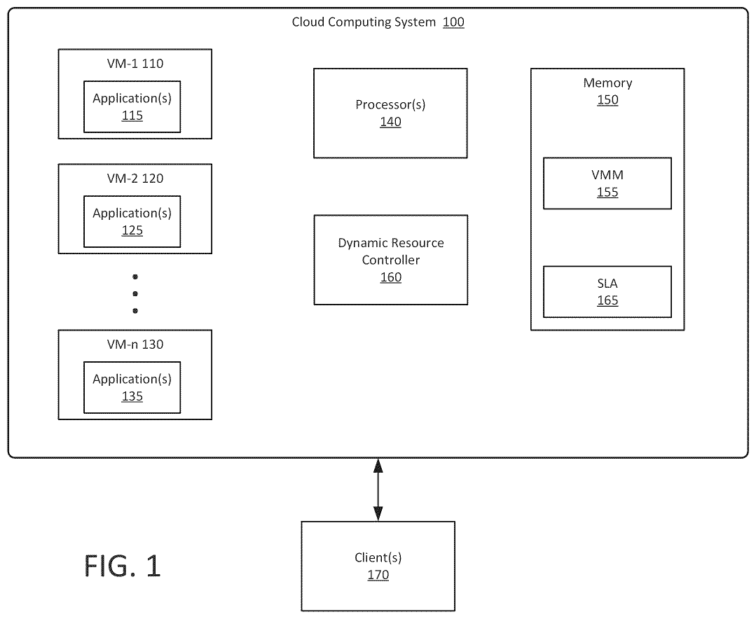

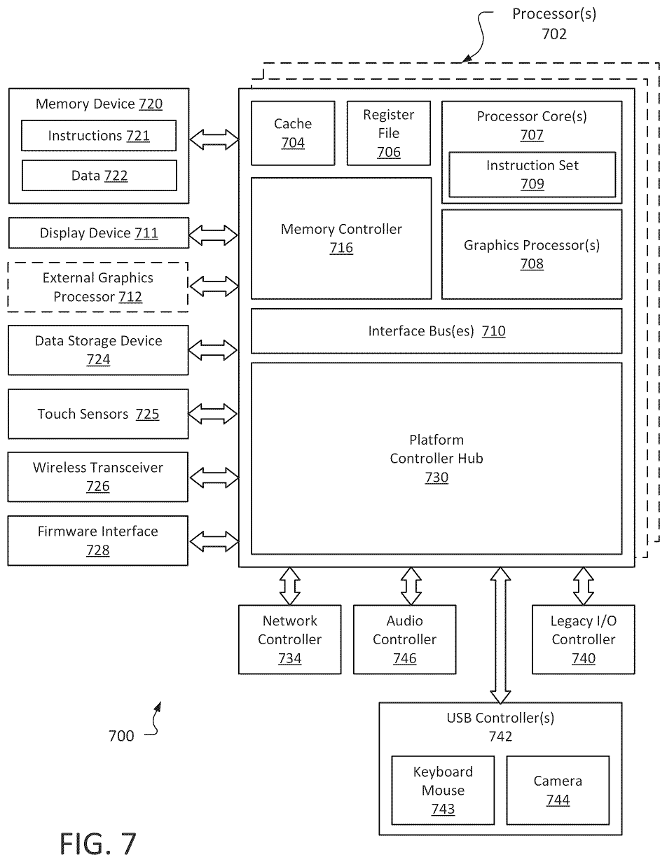

FIG. 1 is an illustration of an apparatus or system to provide enforcement of maximum memory access latency for virtual machine instances, according to some embodiments. As illustrated, a cloud computing system 100, which may include hardware in multiple locations, is to provide support for multiple virtual machines. The cloud computing system 100 may be operated by a cloud service provider (CSP) to serve one or more clients 170. The cloud computing system is illustrated in a high level fashion in FIG. 1, where additional elements may be illustrated in FIGS. 7-9. There may be any number of virtual machines that are supported by the cloud computing system, which in FIG. 1 are illustrated as n-number of virtual machines (where n can be any positive integer), the virtual machines being VM-1 110, VM-2 120, and continuing through VM-n 130. Each virtual machine may support one or more applications that are run on the virtual machine, such as one or more applications 115 run on VM-1 110, one or more applications 125 run on VM-2 120, and one or more applications 135 run on VM-n 130. The virtual machines may each process one or more workloads at any time, wherein a workload refers to an amount of work to be performed by a component or virtual machine in a given period of time.

In addition to other elements, the cloud computing system 100 includes one or more processors 140, which may include multiple cores, the one or more processors 140 to perform processing including processing of workloads for the virtual machines 110, 120, and 130. The cloud computing system 100 further includes memory 150, which may be accessed for reading and writing of data in the processing of the workloads. The memory 150 may include a virtual machine manager (VMM, also referred to as a hypervisor) 155, which is software that creates and runs virtual machines. A VMM 155 allows one host computer to support multiple guest VMs by virtually sharing its resources, such as memory and processing.

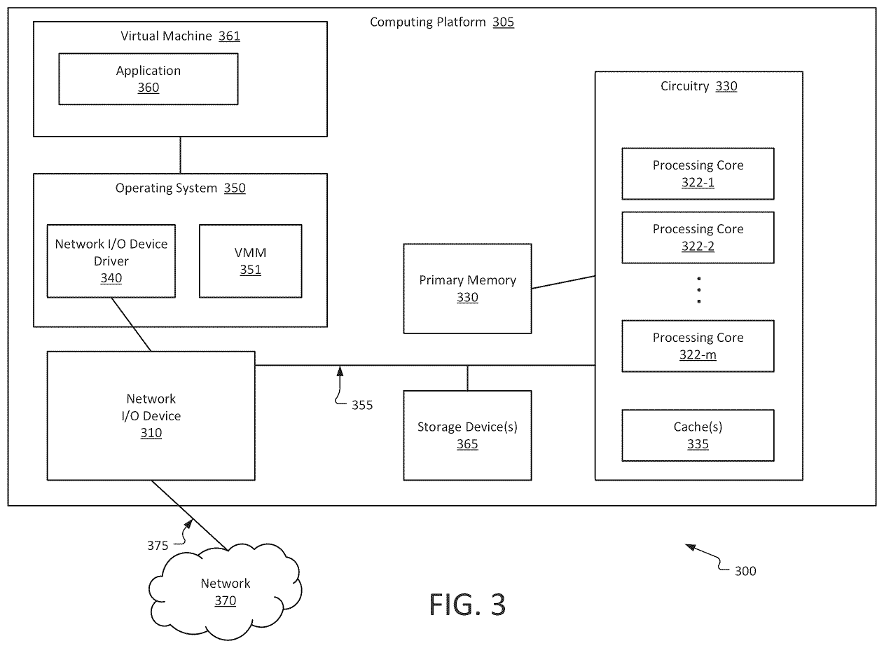

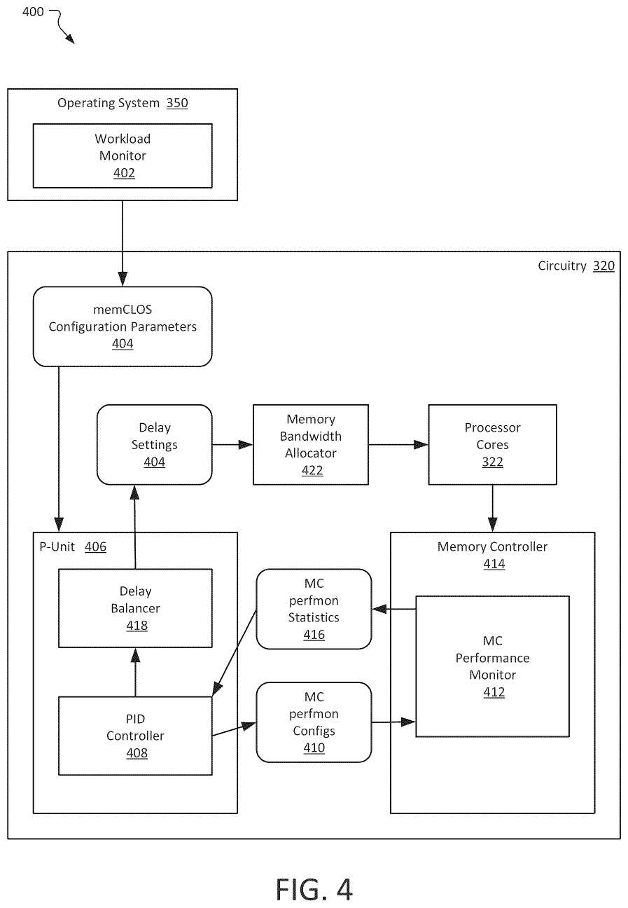

In some embodiments, the cloud computing system 100 includes a dynamic resource controller (DRC) 160 to allocate memory resources, the dynamic resource controller including the capability to monitor memory bandwidth usage, and to detect memory bandwidth saturation. The DRC 160 includes counters that can be utilized in detecting memory accesses. The DRC is further described in connection with FIGS. 3 and 4. In some embodiments, the DRC 160 includes capability to monitor memory bandwidth usage in operation of the virtual machines, and to detect when the memory access reaches a saturation point in which a memory bandwidth threshold is exceeded. Upon detecting that the threshold has been exceeded in a cloud computing system, the DRC 160 is to allocate memory bandwidth among the active workloads being processed by virtual machines, and thereby to throttle any workloads that have excessive memory bandwidth consumption. In some embodiments, the memory bandwidth allocation may be made according to an allocation method or algorithm.

In some embodiments, utilizing the operation of the DRC 160, the cloud computing system 100 is to provide a guarantee of maximum memory access latency for the virtual machines according to a service level agreement (SLA) 165, which is shown as being stored in memory 150. The provision of a maximum memory latency according to the SLA 165 may be utilized to reduce the performance variations in workloads processed by virtual machines 110, 120, 130 in the public cloud.

In some embodiments, a dynamic resource controller 160 applies close loop control to provide memory bandwidth throttling. The memory bandwidth throttling may be applied to maximize the memory bandwidth utilization rate in the virtual machines and to provide fair memory bandwidth allocation between the virtual machines. In an operation, while the memory traffic is in idle, each VM instance may be able to achieve a maximum memory bandwidth required for a workload (as limited by the threshold). When the memory traffic is busy, the DRC 160 is to detect the memory bandwidth contentions, allowing the system to apply VM core count proportional bandwidth throttling. In this manner, each VM instance may be accorded memory access that that meets the maximum memory access latency according to the service level agreement 165.

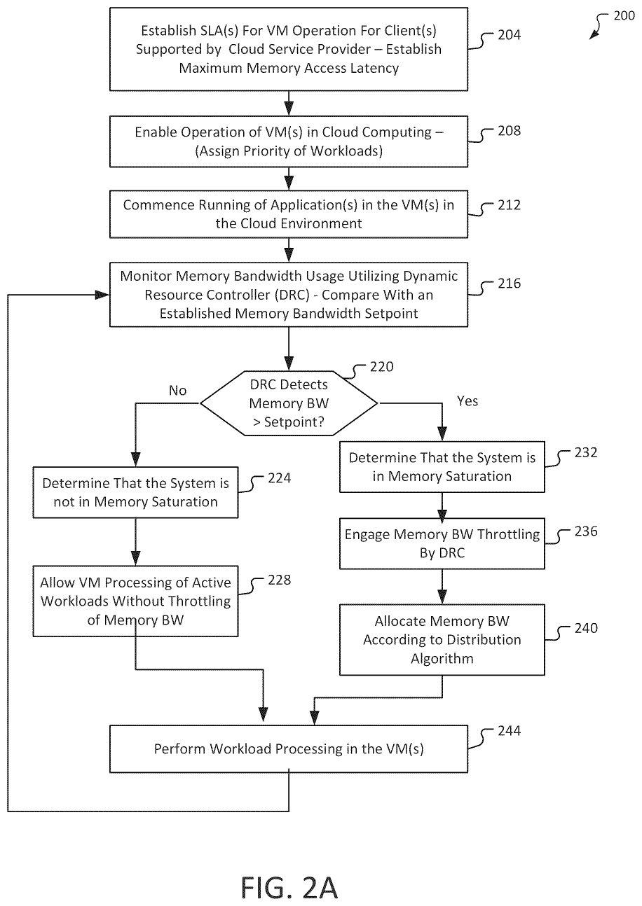

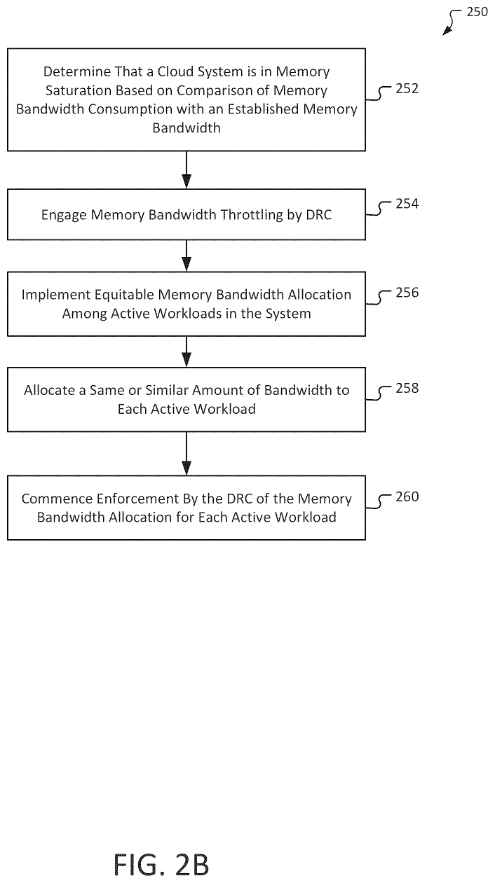

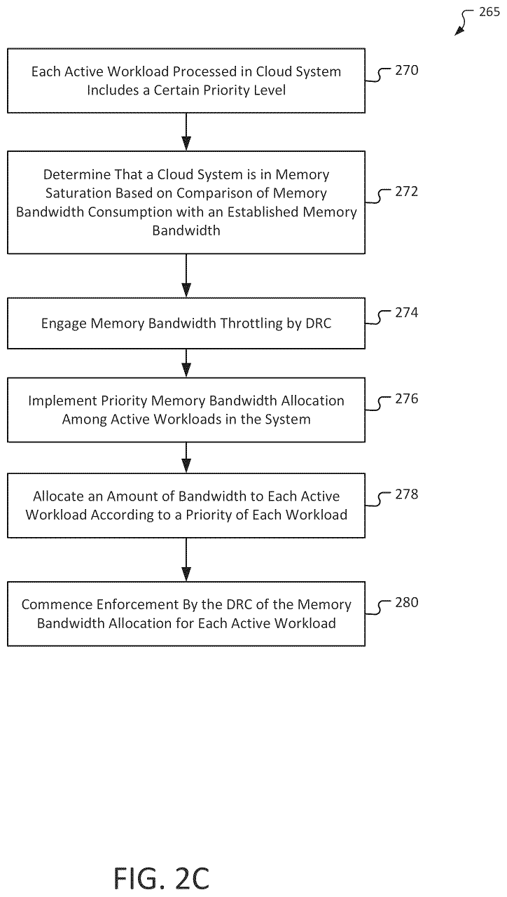

FIG. 2A is an illustration of a process for enforcement of maximum memory access latency for virtual machine instances, according to some embodiments. In some embodiments, a process 200 includes establishing one or more SLAs for one or more clients that are supported by a cloud service provider 204. The one or more SLAs may include establishing a maximum memory access latency for virtual machines that are processing active workloads in a cloud computing system.

In some embodiments, the process 200 further proceeds with enabling operation of one or more virtual machines in the cloud computing system 208. The enablement of the operations may include establishing certain priority levels for workloads to be processed by the one or more virtual machines, such as establishing a first priority level that is a high priority level for a first set of workloads and a second priority level that is low priority level for a second set of workloads. However, the priority levels are not limited to two priority levels, and may include any number of levels. One or more applications may begin running in the one or more virtual machines in the cloud environment 212, where application may include a particular workload. The operation of the applications may include performing memory accesses to read data from or write data to a memory, such as memory 150 illustrated in FIG. 1.

In some embodiments, the process 200 includes monitoring memory bandwidth usage utilizing a dynamic resource controller (DRC) 216. The monitoring may include comparing memory bandwidth consumption with an established memory bandwidth setpoint. In some embodiments, the setpoint may be set or modified in response to a request from one or more clients.

A determination may be made whether detected memory bandwidth consumption is greater than the established memory bandwidth setpoint 220. If the detected memory bandwidth consumption is not more than the setpoint, then the DRC may determine that the system is not in memory saturation 224, and the virtual machine operations to process the one or more workloads are allowed without throttling of memory bandwidth 228.

If the detected memory bandwidth consumption is greater than the setpoint, then the DRC may determine that the system is in memory saturation 232. Memory bandwidth throttling is engaged 236, and the DRC is to allocate memory bandwidth to active workloads according to a distribution method 240. The distribution method may vary according to implementation, including allocation of memory bandwidth may be as illustrated in FIGS. 2B and 2C.

The process 200 then proceeds with performing workload processing in the virtual machines 244, and continuing monitoring of the memory bandwidth usage 216.

FIG. 2B is an illustration of equitable memory bandwidth allocation, according to some embodiments. In a process 250, which may be a part of the process 200 illustrated in FIG. 2A, a determination may be made that a cloud computing system is in memory saturation based on caparison of memory bandwidth consumption with an established memory bandwidth setpoint 252.

In response to the determination, the process provides for engaging memory bandwidth throttling by a DRC 254, and implementing equitable memory bandwidth among active workloads in the system 256. In some embodiments, each active workload is allocated a same or similar amount of memory bandwidth 258. In some embodiments, the DRC commences enforcement of the memory bandwidth allocation for each active workload 260.

FIG. 2C is an illustration of priority-based memory bandwidth allocation, according to some embodiments. In a process 265, which may be a part of the process 200 illustrated in FIG. 2A, each active workload processed by virtual machines in a cloud computing system includes a certain priority level 270. In certain implementations, there may be at least a high priority level and a low priority level for workloads, but embodiments are not limited to these particular priority levels. Workloads may be assigned a priority by default in various instances. For example, a certain set of workloads may be designated as high priority loads, while all other workloads may be default be low priority workloads.

In some embodiments, a determination may be made that the cloud computing system is in memory saturation based on caparison of memory bandwidth consumption with an established memory bandwidth setpoint 272. In response to the determination, the process 265 provides for engaging memory bandwidth throttling by a DRC 274, and implementing implementation of a priority memory bandwidth allocation among active workloads in the system 276.

In some embodiments, each active workload is allocated an amount of memory bandwidth according to the priority of the workload 278. For example, each high priority workload is allocated a first amount of memory bandwidth and each low priority workload is allocated a second amount of memory bandwidth, the second amount being a smaller amount of memory bandwidth. In this manner, the high priority workloads may continue with less memory bandwidth throttling in the memory saturation state. In some embodiments, the DRC commences enforcement of the memory bandwidth allocation for each active workload 280.

FIG. 3 is an illustration of an example computing system. As shown in FIG. 3, a computing system 300 includes a computing platform 305 coupled to a network 370 (which may be the Internet, for example). In some examples, as shown in FIG. 3, computing platform 305 is coupled to network 370 via network communication channel 375 and through at least one network (NW) input/output (I/O) device 310. In an embodiment, network I/O device 310 comprises a switch and a network interface controller (NIC) having one or more destination ports (not shown) connected or coupled to network communication channel 375. In an embodiment, network communication channel 375 includes a PHY device (not shown). In an embodiment, network I/O device 310 includes an Ethernet NIC. Network I/O device 310 transmits data packets from computing platform 305 over network 370 to other destinations and receives data packets from other destinations for forwarding to computing platform 305.

According to some examples, computing platform 305, as shown in FIG. 3, includes circuitry 320, primary memory 330, operating system (OS) 350, NW I/O device driver 340, virtual machine manager (VMM) (also known as a hypervisor) 351, at least one application 360 running in a virtual machine (VM) 361, and one or more storage devices 365. In one embodiment, OS 350 is Linux™. In another embodiment, OS 350 is Windows® Server. Other OSs may also be used. Network I/O device driver 340 operates to initialize and manage I/O requests performed by network I/O device 310. In an embodiment, packets and/or packet metadata transmitted to network I/O device 310 and/or received from network I/O device 310 are stored in one or more of primary memory 330 and/or storage devices 365. In one embodiment, application 360 is a packet processing application operating in user mode.

In at least one embodiment, storage devices 365 may be one or more of hard disk drives (HDDs) and/or solid-state drives (SSDs). In an embodiment, storage devices 365 may be non-volatile memories (NVMs). In some examples, as shown in FIG. 3, circuitry 320 may communicatively couple to network I/O device 310 via communications link 355. In one embodiment, communications link 355 is a peripheral component interface express (PCIe) bus conforming to version 3.0 or other versions of the PCIe standard published by the PCI Special Interest Group (PCI-SIG). In some examples, operating system 350, NW I/O device driver 340, VM 361, and application 360 are implemented, at least in part, via cooperation between one or more memory devices included in primary memory 330 (e.g., volatile or non-volatile memory devices), storage devices 365, and elements of circuitry 320 such as processing cores 322-1 to 322-m, where “m” is any positive whole integer greater than 1. In one embodiment, only a single processing core is included. In an embodiment, OS 350, VMM 351, NW I/O device driver 340, VM 361 and application 360 are executed by one or more processing cores 322-1 to 322-m.

In some examples, computing platform 305, includes but is not limited to a server, a server array or server farm, a web server, a network server, an Internet server, a workstation, a mini-computer, a main frame computer, a supercomputer, a network appliance, a web appliance, a distributed computing system, multiprocessor systems, processor-based systems, a laptop computer, a tablet computer, a smartphone, a system-on-a-chip (SoC), or a combination thereof. In one example, computing platform 305 is a disaggregated server. A disaggregated server is a server that breaks up components and resources into subsystems (e.g., network sleds). Disaggregated servers can be adapted to changing storage or compute loads as needed without replacing or disrupting an entire server for an extended period of time. A server could, for example, be broken into modular compute, I/O, power and storage modules that can be shared among other nearby servers.

Circuitry 320 having processing cores 322-1 to 322-m may include various commercially available processors, including without limitation Intel® Atom®, Celeron®, Core (2) Duo®, Core i3, Core i5, Core i7, Itanium®, Pentium®, Xeon® or Xeon Phi® processors, ARM processors, processors from Applied Micro Devices, Inc., and similar processors. Circuitry 320 may include at least one cache 335 to store data.

According to some examples, primary memory 330 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAIVI). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAIVI), magneto-resistive random-access memory (MRAIVI) that incorporates memristor technology, spin transfer torque MRAIVI (STT-MRAIVI), or a combination of any of the above. In another embodiment, primary memory 330 may include one or more hard disk drives within and/or accessible by computing platform 305.

Resource Director Technology (RDT), commercially available from Intel Corporation, provides a framework for cache and memory monitoring and allocation capabilities in a processor, including cache monitoring technology (CMT), cache allocation technology (CAT), code and data prioritization (CDP), memory bandwidth monitoring (MBM), and memory bandwidth allocation (MBA). These technologies enable tracking and control of shared resources, such as last-level cache (LLC) and primary memory 330 bandwidth in use by applications 360 and/or VMs 361 running on computing platform 305 concurrently. RDT may aid noisy neighbor detection and help to reduce performance interference, ensuring the performance of key workloads in complex computing environments meets QoS requirements.

Cache Allocation Technology (CAT) provides software-programmable control over the amount of cache space that can be consumed by a given thread, application, virtual machine (VM), or container. This allows, for example, OSs to protect important processes, or hypervisors to prioritize important VMs even in a noisy datacenter environment. The basic mechanisms of CAT include the ability to enumerate the CAT capability and the associated last-level cache (LLC) allocation support via CPUID, and the interfaces for the OS/hypervisor to group applications into classes of service (CLOS) and indicate the amount of last-level cache available to each CLOS. These interfaces are based on Model-Specific Registers (MSRs). As software enabling support is provided, most users can leverage existing software patches and tools to use CAT.

The CMT feature provides visibility into shared platform resource utilization (via L3 cache occupancy), which enables improve application profiling, better scheduling, improved determinism, and improved platform visibility to track down applications which may be over-utilizing shared resources and thus reducing the performance of other co-running applications. CMT exposes cache consumption details, which allows resource orchestration software to ensure better Service Level Agreement (SLA) attainment.

MBA technology enables approximate and indirect control over the memory bandwidth available to workloads, enabling interference mitigation and bandwidth shaping for noisy neighbors present in computing platform 305. MBA provides per-core controls over bandwidth allocation. MBA is included between each core and a shared high-speed interconnect which connects the cores in some multi-core processors. This enables bandwidth downstream of shared resources, such as memory bandwidth, to be controlled. MBA is complementary to existing RDT features such as CAT. For instance, CAT may be used to control the last-level cache, while MBA may be used to control memory bandwidth. The MBA feature extends the shared resource control infrastructure introduced with CAT. The CAT architecture defines a per-software-thread tag called a Class of Service (CLOS), which enables running threads, applications or VMs to be mapped to a particular bandwidth. Through central processing unit (CPU) identifier (CPUID)-based enumeration, the presence of the MBA feature can be confirmed on a specific processor. Once enumerated as present, details such as the number of supported classes of service and MBA feature specifics such as throttling modes supported may be enumerated.

In typical usages an enabled OS 350 or VMM 351 will maintain an association of processing threads to a CLOS. Typically, when a software thread is swapped onto a given logical processor, a model specific register (MSR) such as IA32_PQR_ASSOC MSR (for an Intel Corporation Xeon® processor, for example) is updated to reflect the CLOS of the thread. MBA bandwidth limits per-CLOS are specified as a value in the range of zero to a maximum supported level of throttling for the platform (available via CPUID), typically up to 90% throttling, and typically in 10% steps. These steps are approximate, and represent a calibrated value mapped to a known bandwidth-intense series of applications to provide bandwidth control. The resulting bandwidth for these calibration points provided may vary across system configurations, generations and memory configurations, so the MBA throttling delay values should be regarded as a hint from software to hardware about how much throttling should be applied.

FIG. 4 illustrates an example of dynamic control of memory bandwidth allocation according to some embodiments. Arrangement 400 of components includes workload monitor 402 implemented in software. In one embodiment, workload monitor 402 is a component within OS 350 to monitor workloads (e.g., applications 360 or parts of applications) running on processor cores 322. Computing platform hardware 305 includes processor cores 322 (e.g., one or more instances of cores 322-1 to 322-m), memory controller (MC) 414, P-unit 406, and memory bandwidth allocator (MBA) 422, all part of processor circuitry 320. P-unit 406 uses memCLOS configuration parameters 404 set by workload monitor 402 to determine delay settings 420 (also called memory bandwidth settings), which are passed to MBA 422. MBA 422 communicates with processor cores 322, which are coupled to MC 414. As processor cores process instructions of workloads, MC performance monitor (perfmon) 412 within MC 414 gathers MC perfmon statistics 416 based at least in part on parameters set in MC perfmon configurations (configs) 410. MC perfmon statistics 416 are passed to proportional-integral-derivative (PID) controller 408 within P-unit 404, which may then cause delay balancer 418 to change delay settings 420 as needed. Thus, PID controller 408 and delay balancer 418 implement a control loop mechanism employing feedback that is widely used in applications requiring continuously modulated control. PID controller 408 continuously calculates an error value as the difference between a desired set point (SP) and a measured (e.g., monitored) process variable (PV) (such as RPQ_occupancy for example) and applies a correction based on proportional, integral. and derivative terms (denoted P, I, and I) respectively). PID controller automatically applies accurate and responsive corrections to a control function (e.g., memory bandwidth allocation in one embodiment).

In embodiments of the present invention, delay balancer 418, based at least in part from inputs from PID controller 408, determines delay settings 420 (e.g., memory bandwidth settings) to be applied by MBA 422 for processor cores 322 to adjust the priorities of memory bandwidth for workloads being processed by the cores.

In one embodiment, memCLOS configuration parameters 404 are communicated from workload monitor 402 to P-unit 406 using a mailbox implementation provided by OS 150. A mailbox may be used for SW/BIOS to communicate with the processor for feature discovery and control. There are two registers which form the mailbox interface: one is the interface register which is used to control and specify the command, and the other is the data register. The busy bit is set and the operation to modify or control is specified. If the operation is a write, the data register carries the write data; and if the operation is a read, the content read back is stored in the data register.

In another embodiment, new MSRs (not shown in FIG. 4) for storing memCLOS configuration parameters 404 are defined and implemented in processor circuitry 320 to extend existing CLOS configurations as defined in RDT.

In some embodiments, memory bandwidth and latency are mapped to one or more configurable metrics. In one embodiment, a specific metric called RPQ_occupancy can be used. A control loop is implemented in P-unit 406 firmware maintaining favorable memory latency characteristics for high priority tasks and detecting unfavorable scenarios where high priority tasks can suffer performance loss due to memory bandwidth/latency degradation by monitoring, for example, system RPQ_occupancy. Delay balancer 418 in P-unit 406 automatically throttles (delays) access to memory bandwidth of low priority CLOS cores when, for example, a system RPQ_occupancy value crosses above a set point and restores high priority memory bandwidth/latency. Delay balancer 418 uses the RDT/MBA interface provided by MBA 422 to achieve throttling of low priority processor cores 322.

In one embodiment, the plurality of delay settings (e.g., memory bandwidth settings) comprises a delay value for memory bandwidth allocation for a low priority processor core based on a memory class of service (memCLOS) of (e.g., assigned to) the low priority processor core. In an embodiment, the one or more of the plurality of delay settings comprises a delay value of zero (e.g., no delay) for memory bandwidth allocation for a high priority processor core based on a memCLOS of (e.g., assigned to) the high priority processor core.

In one embodiment, a PID controller 408 loop in P-unit 406 firmware monitors, for example, RPQ_occupancy of computing platform 305 and when RPQ_occupancy crosses a set point, delay balancer 418 throttles (delays) the low priority processor cores based on their memCLOS definition. In an embodiment, memCLOS configuration parameters 404 can be programmed by workload monitor 402 as shown below in tables 1 and 2, and MC perfmon configs 410 (such as an RPQ_occupancy setpoint) for the system can be programmed as shown below in table 3. In other embodiments, other MC perfmon statistics 416 can be monitored as determining metrics for dynamically adjusting memory bandwidth allocation (or other shared resources).

Thus, a practical design interface to add additional QoS levels for different priority workloads is accomplished in embodiments with the extension to CLOS called memCLOS.

In an embodiment, memCLOS configuration parameters 404 includes a control bit used to enable the memCLOS feature. When set (e.g., set to 1), the memCLOS feature is enabled for computing platform 305. In one embodiment, the enable memCLOS control bit is implemented as a fuse in circuitry 320 that can be blown when the memCLOS capability is authorized.

TABLE 1
Enable memCLOS included in memCLOS
configuration parameters 404

| Name | Description | Bits | Width |
|---|---|---|---|
| MemCLOS_EN | Enables MemCLOS feature for the | 1 | 1 |
| | processor package/die | | |

In an embodiment, memCLOS configuration parameters 404 include an extension of CLOS IDs that map (e.g., correspond) to memCLOS IDs. There are four different types of memCLOS supported, each type being indicated by an identifier (ID). In one embodiment, there are 16 CLOS and 4 memCLOS. In other embodiments, other numbers of CLOS and memCLOS can be used.

TABLE 2
CLOS to memCLOS mapping included in
memCLOS configuration parameters 404

| Name | Description | Bits | Width |
|---|---|---|---|
| CLOS0MemCLOS | Mapping of CLOS0 to | 1:0 | 2 |
| | MemCLOS | | |
| CLOS1MemCLOS | Mapping of CLOS1 to | 3:2 | 2 |
| | MemCLOS | | |
| CLOS2MemCLOS | Mapping of CLOS2 to | 5:4 | 2 |
| | MemCLOS | | |
| CLOS3MemCLOS | Mapping of CLOS3 to | 7:6 | 2 |
| | MemCLOS | | |
| CLOS4MemCLOS | Mapping of CLOS4 to | 9:8 | 2 |
| | MemCLOS | | |
| CLOS5MemCLOS | Mapping of CLOS5 to | 11:10 | 2 |
| | MemCLOS | | |
| CLOS6MemCLOS | Mapping of CLOS6 to | 13:12 | 2 |
| | MemCLOS | | |
| CLOS7MemCLOS | Mapping of CLOS7 to | 15:14 | 2 |
| | MemCLOS | | |
| CLOS8MemCLOS | Mapping of CLOS8 to | 17:16 | 2 |
| | MemCLOS | | |
| CLOS9MemCLOS | Mapping of CLOS9 to | 19:18 | 2 |
| | MemCLOS | | |
| CLOS10MemCLOS | Mapping of CLOS10 to | 21:20 | 2 |
| | MemCLOS | | |
| CLOS11MemCLOS | Mapping of CLOS11 to | 23:22 | 2 |
| | MemCLOS | | |
| CLOS12MemCLOS | Mapping of CLOS12 to | 25:24 | 2 |
| | MemCLOS | | |
| CLOS13MemCLOS | Mapping of CLOS13 to | 27:26 | 2 |
| | MemCLOS | | |
| CLOS14MemCLOS | Mapping of CLOS14 to | 29:28 | 2 |
| | MemCLOS | | |
| CLOS15MemCLOS | Mapping of CLOS15 to | 31:30 | 2 |
| | MemCLOS | | |

In one embodiment, MC perfmon configs 410 specify closed loop parameter settings which configure a perfmon event to be monitored by MC perfmon 412 (such as RPQ_occupancy, for example), a set point limit of the event threshold, and a time window, for all memCLOS.

TABLE 3
MC Perfmon Configs 404 Fields

| Field Name | Description | Bits | Width |
|---|---|---|---|
| MemCLOS_Setpoint | MemCLOS set point threshold value. | 7:0 | 8 |
| | For example, used to set RPQ occupancy set | | |
| | point value (e.g., threshold) or for whatever | | |
| | event is to be monitored. | | |
| MemCLOS_Time | MemCLOS time window . . . | 15:8 | 8 |
| Window | For example, used to set RPQ occupancy | | |
| | time window or for whatever event is to be | | |
| | monitored. How often to monitor the event | | |
| | (e.g., 1 millisecond (ms), 2 ms, etc.) | | |
| MemCLOS_Event | MemCLOS event. | 23:16 | 8 |
| | Indicates which event will be monitored by | | |
| | MC perfmon 412 | | |
| MemCLOS_Event_EN | Enables or disables event monitoring per | 24 | 1 |
| | event. | | |

For multiple events to be monitored, fields memCLOS_Event and memCLOS_Event_EN are repeated for each monitored event. In an embodiment, the time window is set for computing an exponential weighted moving average (EWMA) for MC perfmon statistics 416.

In one embodiment, memCLOS configuration parameters 404 includes four sets of memCLOS attributes as shown below, one per memCLOS, as selected by the memCLOS CLOSID field.

TABLE 4
memCLOS attributes per memCLOS included
in memCLOS configuration parameters 404

| Field Name | Description | Bits | Width |
|---|---|---|---|
| MemCLOS_Priority | Memory priority setting of this memCLOS | 7:0 | 8 |
| | 0x0 = Highest priority | | |
| | 0xFF = Lowest priority | | |
| MemCLOS_Min | Minimum MBA delay for this memCLOS | 15:8 | 8 |
| MemCLOS_Max | Maximum MBA delay for this memCLOS | 23:16 | 8 |
| MemCLOS_CLOSID | MemCLOS ID | 25:24 | 2 |

Delay settings 420 as set by delay balancer 418 to specify MBA parameters for use by MBA 422.

Embodiments of the present invention prevent low priority applications from accessing shared resources when a specific threshold in resource usage is reached. In order to achieve this, PID controller 408 monitors MC perfmon statistics 416 and ensures monitored events stay within set limits. PID controller 408 uses a control feedback mechanism which calculates an error value between a specified set point and the MC perfmon statistics, and applies corrections based on proportional, integral and derivative terms. The output of the PID controller is used by delay balancer 418 to set the MBA delay settings 420 (e.g., memory bandwidth settings) for one or more processor cores 322 depending on their priorities, where high priority processor cores get low delay values for their access to memory while low priority processor cores get high delay values.

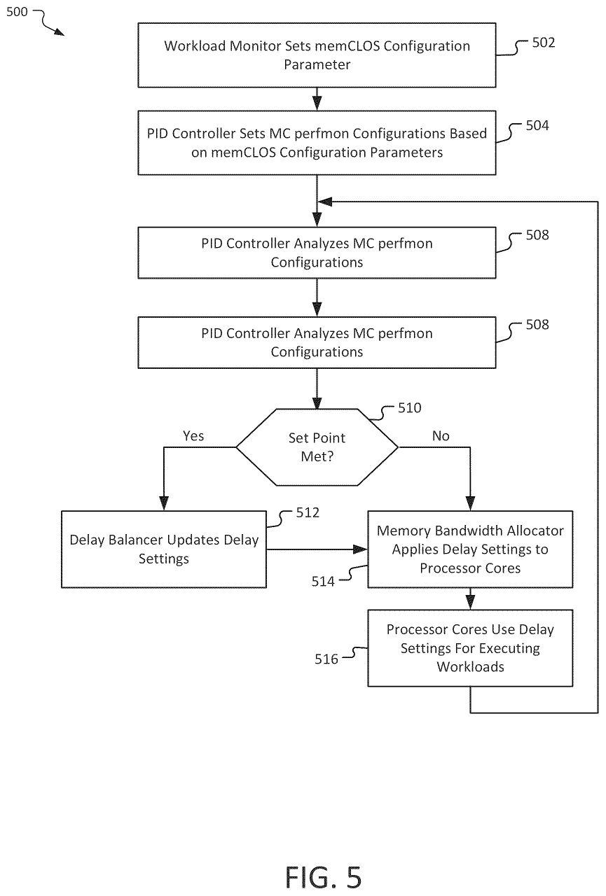

FIG. 5 is a flow diagram illustrating example dynamic control of memory bandwidth allocation processing according to some embodiments. In a process 500, at block 502, workload monitor 402 sets memCLOS configuration parameters 404 (e.g., enables the memCLOS functionality and sets CLOS to memCLOS mappings). PID controller 408 (implemented in one embodiment as firmware in P-unit 406) is activated when MemCLOS EN is set. At block 504, PID controller 408 sets MC perfmon configs 410 based at least in part on memCLOS configuration parameters 404. In an embodiment, MC perfmon configs 410 are set to enable memory statistics of a desired event, which gives insight into memory bandwidth utilization. At block 506, MC perfmon 412 generates MC perfmon statistics 416 based on workloads executed by processor cores 322. At block 508, PID controller 408 periodically reads MC perfmon statistics 410 generated by MC perfmon 412 and analyzes the MC perfmon statistics. If PID controller 408 determines, based on analysis of the MC perfmon statistics, that a memCLOS set point has been met, then PID controller 408 causes delay balancer 418 to update delay settings 420 at block 512. Delay settings 420 are used to dynamically throttle memory bandwidth of any low priority processing cores when bandwidth contention issues arise. In an embodiment, delay balancer 418 distributes a delay budget amongst the various memCLOS classes based on a priority value for each memCLOS. For example, high priority processing cores can be given less delay (perhaps even a delay value of zero) and low priority processing cores can be given more delay. Otherwise, if the set point has not been met, no update of the delay settings is made. In either case, processing continues with block 514 where memory bandwidth allocator 422 applies delay settings 420 to processor cores. At block 516, processor cores 322 use the delay settings for executing workloads. Processing continues in a closed loop back at block 506 with the gathering of new MC perfmon statistics. In an embodiment, the closed loop is repeated periodically to continuously dynamically adjust memory bandwidth.

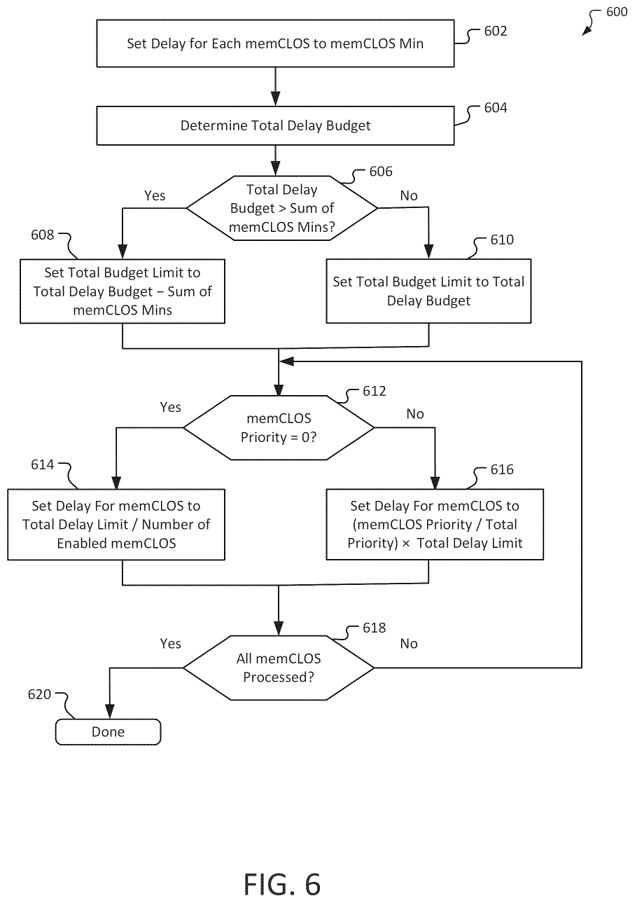

FIG. 6 is a flow diagram illustrating a delay balancer processing according to some embodiments. In a process 600, at block 602, delay balancer 418 sets a delay value for each memCLOS to a minimum memCLOS value. At block 604, delay balancer 418 determines a total delay budget for circuitry 320. In an embodiment, the total delay budget is set to the output of PID controller 408 multiplied by the number of enabled memCLOS. At block 606, if the total delay budget is greater than a sum of the memCLOS minimum values, then at block 608, delay balancer 418 sets a total delay limit to the total delay budget minus the sum of the memCLOS minimum values. Otherwise, delay balancer 418 sets the total delay limit to the total delay budget at block 610. Processing continues with a first memCLOS at block 612. If the priority of this memCLOS is 0 (indicating high priority in one embodiment), then at block 614 delay balancer 418 sets a delay for this memCLOS to the total delay limit divided by the number of enabled memCLOS. If the priority of this memCLOS is not 0 (indicating a lower priority than the highest setting), then at block 416 delay balancer 418 sets the delay for this memCLOS to the priority of this memCLOS divided by the total of all priority values multiplied by the total delay limit. Thus, in one embodiment, setting each of the plurality of delay settings to a delay value is based at least in part on the total delay budget and the priority of the selected memCLOS. Next, at block 618 if not all memCLOS have been processed, then block 612, 614 or 616 are performed for the next memCLOS. If all memCLOS have been processed, delay balancer processing ends at block 620. The updated delay settings 420 are then input to memory bandwidth allocator 422.

With features of embodiments of the present invention enabled, a firmware-based dynamic resource controller (DRC) for memory bandwidth allocation as described herein maintains approximately 90% to 97% of the performance of high priority workloads of search, redis, and specCPU2006 launched along with low priority noisy workloads like stream and specCPU2006. Noisy aggressors such as stream and specCPU workloads can degrade high priority workload performance by approximately 18% to 40% if DRC is not present. With a noisy memory aggressor, and DRC enabled, some embodiments can maintain approximately 90% to 97% of high priority core baseline performance. With embodiments of the present invention, overall processor utilization is improved from approximately 65% to 90% compared with approximately 25% to 45% with high priority cores alone.

Also, comparing to software implemented similar control logic, the firmware-based dynamic resource controller as described herein implemented using existing processor hardware will save up to 90% of a processor core depending on the sampling interval and improve monitor/control and response action convergence in 10 s of milliseconds (ms) granularity. In contrast, a SW controller can only respond within 100 s of ms because of kernel/user space SW overheads.

There are at least several advantages of embodiments of the present invention. The dynamic resource controller as described herein which uses RDT features such as memory bandwidth allocation (MBA) can be easily adopted in different CSP SW frameworks without requiring any changes to their SW frameworks. Embodiments provide a fast response (target 1 millisecond (ms)) through a control mechanism (e.g., P-unit 406) in processor firmware. When bad behavior is detected, processor firmware logic in P-unit 404 throttles bandwidth to lower priority memCLOS through MBA in a closed loop action which will help remove potential performance jitter within a fast interval. The end user will not notice the noisy workload impact because of the fast action. Embodiments of the present invention are autonomous, dynamic, and do not involve any additional hardware overhead. Current RDT solutions are static and can be overly restrictive for cases where throttling is not needed. Embodiments of the present invention provide a dynamic controller that throttles memory bandwidth access only when needed. Measurements show that if the control loop is implemented in SW, the control loop can consume almost a single processor core. Embodiments can save a single virtual central processing unit (vcpu) compute resource by running the control mechanism in the package control unit (PCU) controller.

The flowcharts illustrated in FIGS. 2A-2C and 5-6, and other processes described herein, may include machine readable instructions for a program for execution by processor circuitry. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

A program may be embodied in software stored on one or more non-transitory computer readable storage media such as a CD or DVD, a hard disk drive (HDD), a solid state drive (SSD), a volatile memory (e.g., Random Access Memory (RAM) of any type, etc.), or a non-volatile memory (e.g., FLASH memory, an HDD, etc.) associated with processor circuitry located in one or more hardware devices. The program or parts thereof may alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Although the example program is described with reference to the flowchart illustrated in FIGS. 2A-2C and 5-6, many other methods of implementing may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

FIG. 7 illustrates an embodiment of an exemplary computing architecture for operations including enforcement of maximum memory access latency for virtual machine instances, according to some embodiments. In various embodiments as described above, a computing architecture 700 may comprise or be implemented as part of an electronic device.

In some embodiments, the computing architecture 700 may be representative, for example, of a computer system that implements one or more components of the operating environments described above. The computing architecture 700 may be utilized to provide enforcement of maximum memory access latency for virtual machine instances, such as described in FIGS. 1-6.

As used in this application, the terms “system” and “component” and “module” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes one or more processors 702 and one or more graphics processors 708, and may be a single processor desktop system, a multiprocessor workstation system, or a server system having a large number of processors 702 or processor cores 707. In one embodiment, the system 700 is a processing platform incorporated within a system-on-a-chip (SoC or SOC) integrated circuit for use in mobile, handheld, or embedded devices.

An embodiment of system 700 can include, or be incorporated within, a server-based gaming platform, a game console, including a game and media console, a mobile gaming console, a handheld game console, or an online game console. In some embodiments system 700 is a mobile phone, smart phone, tablet computing device or mobile Internet device. Data processing system 700 can also include, couple with, or be integrated within a wearable device, such as a smart watch wearable device, smart eyewear device, augmented reality device, or virtual reality device. In some embodiments, data processing system 700 is a television or set top box device having one or more processors 702 and a graphical interface generated by one or more graphics processors 708.

In some embodiments, the one or more processors 702 each include one or more processor cores 707 to process instructions which, when executed, perform operations for system and user software. In some embodiments, each of the one or more processor cores 707 is configured to process a specific instruction set 709. In some embodiments, instruction set 709 may facilitate Complex Instruction Set Computing (CISC), Reduced Instruction Set Computing (RISC), or computing via a Very Long Instruction Word (VLIW). Multiple processor cores 707 may each process a different instruction set 709, which may include instructions to facilitate the emulation of other instruction sets. Processor core 707 may also include other processing devices, such a Digital Signal Processor (DSP).

In some embodiments, the processor 702 includes cache memory 704. Depending on the architecture, the processor 702 can have a single internal cache or multiple levels of internal cache. In some embodiments, the cache memory 704 is shared among various components of the processor 702. In some embodiments, the processor 702 also uses an external cache (e.g., a Level-3 (L3) cache or Last Level Cache (LLC)) (not shown), which may be shared among processor cores 707 using known cache coherency techniques. A register file 706 is additionally included in processor 702 which may include different types of registers for storing different types of data (e.g., integer registers, floating point registers, status registers, and an instruction pointer register). Some registers may be general-purpose registers, while other registers may be specific to the design of the processor 702.

In some embodiments, one or more processor(s) 702 are coupled with one or more interface bus(es) 710 to transmit communication signals such as address, data, or control signals between processor 702 and other components in the system. The interface bus 710, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 702 include an integrated memory controller 716 and a platform controller hub 730. The memory controller 716 facilitates communication between a memory device and other components of the system 700, while the platform controller hub (PCH) 730 provides connections to I/O devices via a local I/O bus.

Memory device 720 can be a dynamic random-access memory (DRAM) device, a static random-access memory (SRAM) device, non-volatile memory device such as flash memory device or phase-change memory device, or some other memory device having suitable performance to serve as process memory. Memory device 720 may further include non-volatile memory elements for storage of firmware. In one embodiment the memory device 720 can operate as system memory for the system 700, to store data 722 and instructions 721 for use when the one or more processors 702 execute an application or process. Memory controller hub 716 also couples with an optional external graphics processor 712, which may communicate with the one or more graphics processors 708 in processors 702 to perform graphics and media operations. In some embodiments a display device 711 can connect to the processor(s) 702. The display device 711 can be one or more of an internal display device, as in a mobile electronic device or a laptop device, or an external display device attached via a display interface (e.g., DisplayPort, etc.). In one embodiment the display device 711 can be a head mounted display (HMD) such as a stereoscopic display device for use in virtual reality (VR) applications or augmented reality (AR) applications.

In some embodiments the platform controller hub 730 enables peripherals to connect to memory device 720 and processor 702 via a high-speed I/O bus. The I/O peripherals include, but are not limited to, an audio controller 746, a network controller 734, a firmware interface 728, a wireless transceiver 726, touch sensors 725, a data storage device 724 (e.g., hard disk drive, flash memory, etc.). The data storage device 724 can connect via a storage interface (e.g., SATA) or via a peripheral bus, such as a Peripheral Component Interconnect bus (e.g., PCI, PCI Express). The touch sensors 725 can include touch screen sensors, pressure sensors, or fingerprint sensors. The wireless transceiver 726 can be a Wi-Fi transceiver, a Bluetooth transceiver, or a mobile network transceiver such as a 3G, 4G, Long Term Evolution (LTE), or 5G transceiver. The firmware interface 728 enables communication with system firmware, and can be, for example, a unified extensible firmware interface (UEFI). The network controller 734 can enable a network connection to a wired network. In some embodiments, a high-performance network controller (not shown) couples with the interface bus 710. The audio controller 746, in one embodiment, is a multi-channel high definition audio controller. In one embodiment the system 700 includes an optional legacy I/O controller 740 for coupling legacy (e.g., Personal System 2 (PS/2)) devices to the system. The platform controller hub 730 can also connect to one or more Universal Serial Bus (USB) controllers 742 connect input devices, such as keyboard and mouse 743 combinations, a camera 744, or other USB input devices.

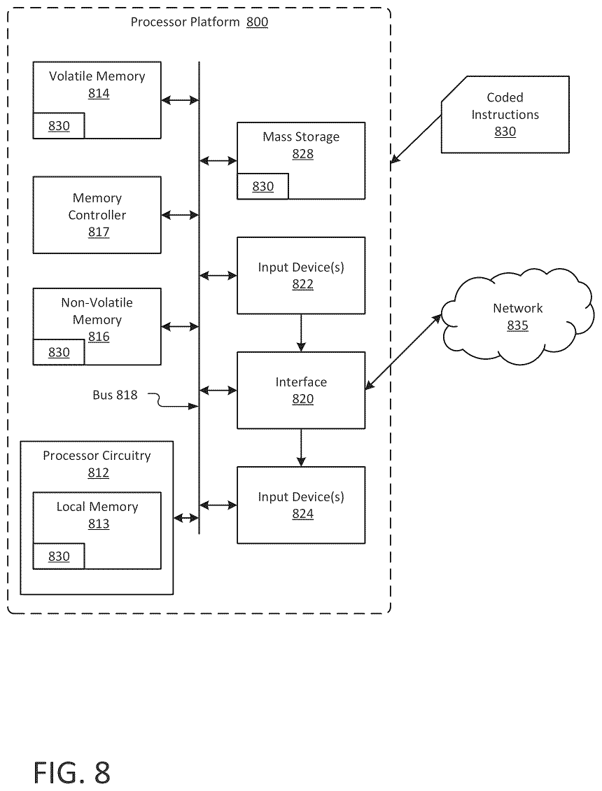

FIG. 8 is a block diagram of an example processor platform structured to execute the machine readable instructions or operations, according to some embodiments. As illustrated, a processor platform 800 can be, for example, a server, a personal computer, a workstation, a self-learning machine (e.g., a neural network), a mobile device (e.g., a cell phone, a smart phone, or a tablet), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs microprocessors, CPUs, GPUs, DSPs, and/or microcontrollers from any desired family or manufacturer. The processor circuitry 812 may be implemented by one or more semiconductor based (e.g., silicon based) devices.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), Dynamic Random Access Memory, and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 835. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 830, which may be implemented by the machine readable instructions of FIGS. 2A-2C and 5-6, may be stored in the mass storage device 828, in the volatile memory 814, in the non-volatile memory 816, and/or on a removable non-transitory computer readable storage medium such as a CD or DVD.

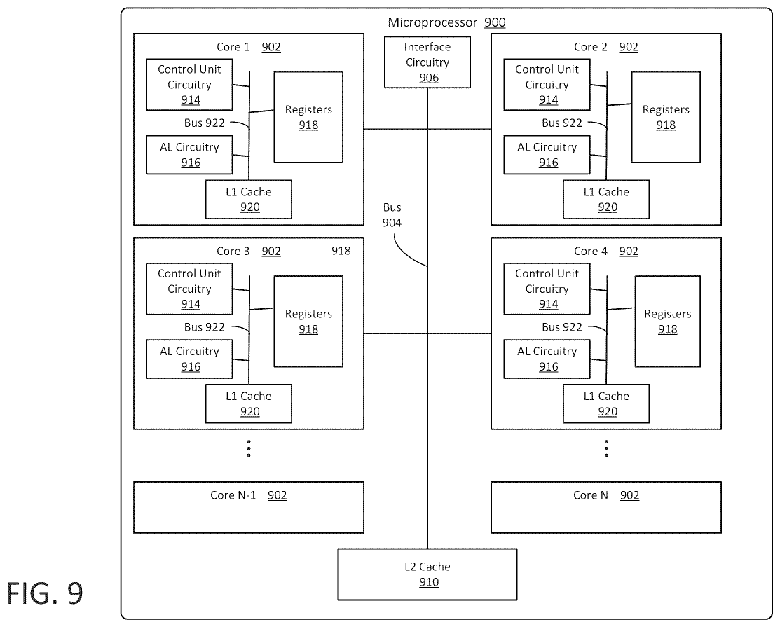

FIG. 9 is a block diagram of an example implementation of processor circuitry. In this example, the processor circuitry is implemented by a microprocessor 900. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIGS. 2A-2C and 5-6.

The cores 902 may communicate by an example bus 904. In some examples, the bus 904 may implement a communication bus to effectuate communication associated with one(s) of the cores 902. For example, the bus 904 may implement at least one of an Inter-Integrated Circuit (I2C) bus, a Serial Peripheral Interface (SPI) bus, a PCI bus, or a PCIe bus. Additionally or alternatively, the bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2) cache) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory. Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and an example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The bus 920 may implement at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

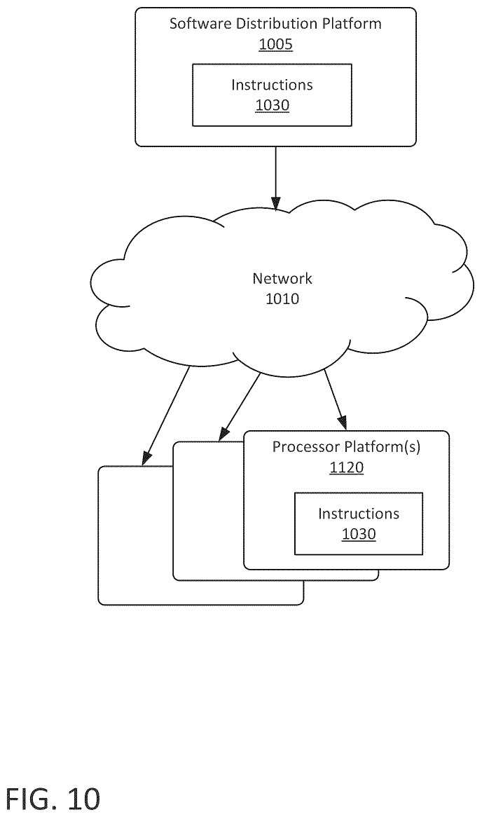

FIG. 10 is a block diagram illustrating an example software distribution platform. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store machine readable instructions 1030.

The one or more servers of the example software distribution platform 1005 are in communication with a network 1010, which may correspond to any one or more of the Internet or other network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1030 from the software distribution platform 1005 to processor platforms 1020. In some examples, one or more servers of the software distribution platform 1005 periodically offer, transmit, and/or force updates to the software to ensure improvements, patches, updates, etc., are distributed and applied to the software at the end user devices.

The following Examples pertain to certain embodiments:

In Example 1, a computer-readable storage medium includes instructions to cause at least one processor to implement operation of a plurality of virtual machines (VMs) in a cloud computing system; monitor operation of the VMs in processing a set of active workloads, including monitoring of memory access latency for the VMs using a dynamic resource controller, the dynamic resource controller comprising hardware circuitry to monitor memory bandwidth usage; and, upon detecting memory access in the cloud computing system reaching a memory bandwidth setpoint, implement memory access throttling of one or more of the set of active workloads for the plurality of VMs, and allocate memory bandwidth to the active workloads according to a distribution algorithm.

In Example 2, the operation of the VMs includes providing service according to a service level agreement (SLA), the SLA including a maximum memory latency value.

In Example 3, the monitoring of the VMs in processing the set of active workloads is independent of characteristics of any workload within the set of active workloads.

In Example 4, the at least one computer-readable storage medium further comprises instructions for execution by the at least one processor that, when executed, cause the at least one processor to establish a value of the memory bandwidth setpoint based on a request.

In Example 5, the distribution algorithm includes distribution of memory bandwidth to the active workloads on an equitable distribution basis, wherein each of active workloads is allocated a same or similar memory bandwidth.

In Example 6, the distribution algorithm includes distribution of memory bandwidth to the active workloads on an priority basis, wherein each of the set of active workloads is allocated memory bandwidth based on which of a plurality of priority levels is assigned to each active workload.

In Example 7, the plurality of priority levels includes at least a first priority level and a second priority level, the first priority level having a higher priority than the second priority level, and distribution of memory bandwidth includes assigning a first amount of memory bandwidth to a workload assigned the first priority level and assigning a second amount of memory to a workload assigned the second priority level, the first amount being greater than the second amount.

In Example 8, the at least one computer-readable storage medium further comprises instructions for execution by the at least one processor that, when executed, cause the at least one processor to, upon detection memory bandwidth that is no greater than the setpoint, allowing operation of the virtual machines without throttling of memory bandwidth.

In Example 9, a method includes implementing operation of a plurality of virtual machines (VMs) in a cloud computing system; monitoring operation of the VMs in processing a set of active workloads, including monitoring of memory access latency for the VMs using a dynamic resource controller, the dynamic resource controller comprising hardware circuitry to monitor memory bandwidth usage; and, upon detecting memory access in the cloud computing system reaching a memory bandwidth setpoint, implementing memory access throttling of one or more of the set of active workloads for the plurality of VMs, and allocating memory bandwidth to the active workloads according to a distribution algorithm.

In Example 10, the operation of the VMs includes providing service according to a service level agreement (SLA), the SLA including a maximum memory latency value.

In Example 11, the monitoring of the VMs in processing the set of active workloads is independent of characteristics of any workload within the set of active workloads.

In Example 12, the method further includes establishing a value of the memory bandwidth setpoint based on a request.

In Example 13, the distribution algorithm includes distribution of memory bandwidth to the active workloads on an equitable distribution basis, wherein each of active workloads is allocated a same or similar memory bandwidth.

In Example 14, the distribution algorithm includes distribution of memory bandwidth to the active workloads on an priority basis, wherein each of the set of active workloads is allocated memory bandwidth based on which of a plurality of priority levels is assigned to each active workload.

In Example 15, the plurality of priority levels includes at least a first priority level and a second priority level, the first priority level having a higher priority than the second priority level, and distribution of memory bandwidth includes assigning a first amount of memory bandwidth to a workload assigned the first priority level and assigning a second amount of memory to a workload assigned the second priority level, the first amount being greater than the second amount.

In Example 16, an apparatus includes one or more processors including a plurality of processing cores, the one or more processors to support operation of a plurality of virtual machines (VMs); and a memory for storage of data, including data for processing of one or more workloads by the plurality of virtual machines, wherein the one or more processors are to implement operation of a plurality of virtual machines (VMs) in a cloud computing system; monitor operation of the VMs in processing a set of active workloads, including monitoring of memory access latency for the VMs using a dynamic resource controller, the dynamic resource controller comprising hardware circuitry to monitor memory bandwidth usage; and, upon detecting memory access in the cloud computing system reaching a memory bandwidth threshold, implement memory access throttling of one or more of the set of active workloads for the plurality of VMs, and allocate memory bandwidth to the active workloads according to a distribution algorithm.

In Example 17, the operation of the VMs includes providing service according to a service level agreement (SLA), the SLA including a maximum memory latency value.

In Example 18, the monitoring of the VMs in processing the set of active workloads is independent of characteristics of any workload within the set of active workloads.

In Example 19, the distribution algorithm includes distribution of memory bandwidth to the active workloads on an equitable distribution basis, wherein each of active workloads is allocated a same or similar memory bandwidth.

In Example 20, the distribution algorithm includes distribution of memory bandwidth to the active workloads on an priority basis, wherein each of the set of active workloads is allocated memory bandwidth based on which of a plurality of priority levels is assigned to each active workload.

In Example 21, an apparatus includes means for implementing operation of a plurality of virtual machines (VMs) in a cloud computing system; means for monitoring operation of the VMs in processing a set of active workloads, including monitoring of memory access latency for the VMs using a dynamic resource controller, the dynamic resource controller comprising hardware circuitry to track memory bandwidth usage; and means for, upon detecting memory access in the cloud computing system reaching a memory bandwidth setpoint, implementing memory access throttling of one or more of the set of active workloads for the plurality of VMs, and allocating memory bandwidth to the active workloads according to a distribution algorithm.

In Example 22, the operation of the VMs includes providing service according to a service level agreement (SLA), the SLA including a maximum memory latency value.

In Example 23, the monitoring of the VMs in processing the set of active workloads is independent of characteristics of any workload within the set of active workloads.

In Example 24, the apparatus further includes means for establishing a value of the memory bandwidth setpoint based on a request.

In Example 25, the distribution algorithm includes distribution of memory bandwidth to the active workloads on an equitable distribution basis, wherein each of active workloads is allocated a same or similar memory bandwidth.

In Example 26, the distribution algorithm includes distribution of memory bandwidth to the active workloads on an priority basis, wherein each of the set of active workloads is allocated memory bandwidth based on which of a plurality of priority levels is assigned to each active workload.

In Example 27, the plurality of priority levels includes at least a first priority level and a second priority level, the first priority level having a higher priority than the second priority level, and distribution of memory bandwidth includes assigning a first amount of memory bandwidth to a workload assigned the first priority level and assigning a second amount of memory to a workload assigned the second priority level, the first amount being greater than the second amount.

In Example 28, the apparatus further includes means for, upon detection memory bandwidth that is no greater than the setpoint, allowing operation of the virtual machines without throttling of memory bandwidth.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

1-20. (canceled)

21. At least one computer-readable storage medium comprising instructions for execution by at least one processor that, when executed, cause the at least one processor to:
implement operation of a plurality of virtual machines (VMs) in a cloud computing system;
monitor operation of the VMs in processing a set of active workloads, including monitoring of memory access latency for the VMs using a dynamic resource controller, the dynamic resource controller comprising hardware circuitry to monitor memory bandwidth usage; and
upon detecting memory access in the cloud computing system reaching a memory bandwidth setpoint:
implement memory access throttling of one or more of the set of active workloads for the plurality of VMs, and
allocate memory bandwidth to the active workloads according to a distribution algorithm.

22. The at least one computer-readable storage medium of claim 21, wherein the operation of the VMs includes providing service according to a service level agreement (SLA), the SLA including a maximum memory latency value.

23. The at least one computer-readable storage medium of claim 21, wherein the monitoring of the VMs in processing the set of active workloads is independent of characteristics of any workload within the set of active workloads.

24. The at least one computer-readable storage medium of claim 21, further comprising instructions for execution by the at least one processor that, when executed, cause the at least one processor to:
establish a value of the memory bandwidth setpoint based on a request.

25. The at least one computer-readable storage medium of claim 21, wherein the distribution algorithm includes distribution of memory bandwidth to the active workloads on an equitable distribution basis, wherein each of active workloads is allocated a same or similar memory bandwidth.

26. The at least one computer-readable storage medium of claim 21, wherein the distribution algorithm includes distribution of memory bandwidth to the active workloads on a priority basis, wherein each of the set of active workloads is allocated memory bandwidth based on which of a plurality of priority levels is assigned to each active workload.

27. The at least one computer-readable storage medium of claim 26, wherein:
the plurality of priority levels includes at least a first priority level and a second priority level, the first priority level having a higher priority than the second priority level, and
distribution of memory bandwidth includes assigning a first amount of memory bandwidth to a workload assigned the first priority level and assigning a second amount of memory to a workload assigned the second priority level, the first amount being greater than the second amount.

28. The at least one computer-readable storage medium of claim 21, further comprising instructions for execution by the at least one processor that, when executed, cause the at least one processor to:
upon detection memory bandwidth that is no greater than the setpoint, allowing operation of the virtual machines without throttling of memory bandwidth.

29. A method comprising:
implementing operation of a plurality of virtual machines (VMs) in a cloud computing system;
monitoring operation of the VMs in processing a set of active workloads, including monitoring of memory access latency for the VMs using a dynamic resource controller, the dynamic resource controller comprising hardware circuitry to monitor memory bandwidth usage; and
upon detecting memory access in the cloud computing system reaching a memory bandwidth setpoint:
implementing memory access throttling of one or more of the set of active workloads for the plurality of VMs, and
allocating memory bandwidth to the active workloads according to a distribution algorithm.

30. The method of claim 29, wherein the operation of the VMs includes providing service according to a service level agreement (SLA), the SLA including a maximum memory latency value.

31. The method of claim 29, wherein the monitoring of the VMs in processing the set of active workloads is independent of characteristics of any workload within the set of active workloads.

32. The method of claim 29, further comprising:
establishing a value of the memory bandwidth setpoint based on a request.

33. The method of claim 29, wherein the distribution algorithm includes distribution of memory bandwidth to the active workloads on an equitable distribution basis, wherein each of active workloads is allocated a same or similar memory bandwidth.

34. The method of claim 29, wherein the distribution algorithm includes distribution of memory bandwidth to the active workloads on a priority basis, wherein each of the set of active workloads is allocated memory bandwidth based on which of a plurality of priority levels is assigned to each active workload.

35. The method of claim 34, wherein:
the plurality of priority levels includes at least a first priority level and a second priority level, the first priority level having a higher priority than the second priority level, and
distribution of memory bandwidth includes assigning a first amount of memory bandwidth to a workload assigned the first priority level and assigning a second amount of memory to a workload assigned the second priority level, the first amount being greater than the second amount.

36. An apparatus comprising:
one or more processors including a plurality of processing cores, the one or more processors to support operation of a plurality of virtual machines (VMs); and
a memory for storage of data, including data for processing of one or more workloads by the plurality of virtual machines;
wherein the one or more processors are to:
implement operation of a plurality of virtual machines (VMs) in a cloud computing system;
monitor operation of the VMs in processing a set of active workloads, including monitoring of memory access latency for the VMs using a dynamic resource controller, the dynamic resource controller comprising hardware circuitry to monitor memory bandwidth usage; and
upon detecting memory access in the cloud computing system reaching a memory bandwidth threshold:
implement memory access throttling of one or more of the set of active workloads for the plurality of VMs, and
allocate memory bandwidth to the active workloads according to a distribution algorithm.

37. The apparatus of claim 36, wherein the operation of the VMs includes providing service according to a service level agreement (SLA), the SLA including a maximum memory latency value.

38. The apparatus of claim 36, wherein the monitoring of the VMs in processing the set of active workloads is independent of characteristics of any workload within the set of active workloads.

39. The apparatus of claim 36, wherein the distribution algorithm includes distribution of memory bandwidth to the active workloads on an equitable distribution basis, wherein each of active workloads is allocated a same or similar memory bandwidth.

40. The apparatus of claim 36, wherein the distribution algorithm includes distribution of memory bandwidth to the active workloads on a priority basis, wherein each of the set of active workloads is allocated memory bandwidth based on which of a plurality of priority levels is assigned to each active workload.
